(19) United States
(12) Patent Application Publication
(10) Pub. No.: US 2014/0226992 A1
(43) Pub. Date: Aug. 14, 2014

(54) SUBSCRIBER-SIDE DEVICE AND OPTICAL TRANSMISSION SYSTEM

(71) Applicant: Koji Takahashi, Tokyo (JP)

(72) Inventor: Koji Takahashi, Tokyo (JP)

(73) Assignee: Mitsubishi Electric Corporation, Tokyo (JP)

(21) Appl. No.: 14/346,892

(22) PCT Filed: Dec. 12, 2011
(86) PCT No.: PCT/JP2011/078680

§ 371 Date: Mar. 24, 2014

(51) Int. Cl. H04L 7/00

(52) U.S. Cl. CPC H04L 7/0075
USPC 398/155

(57) ABSTRACT

An object of the present invention is to provide a subscriber-side device, which can generate accurate time information and can synchronize a time with other device even if a power supply of a portion that receives a downlink signal is in an OFF state, and to provide an optical transmission system including the same. The subscriber-side device of the present invention corrects and outputs free-running time information, which is generated based on a free-running clock signal, by a time correction value generated based on a frequency deviation between a synchronization clock signal and the free-running clock signal. When the downlink signal sent from the station-side device is in a signal interruption state of being incapable of recognizing or receiving the downlink signal, the subscriber-side device corrects and outputs the free-running time information by a time correction value generated before the downlink signal turns to the signal interruption state.

### TECHNICAL FIELD

The present invention relates to a subscriber-side device and an optical transmission system including the same.

### BACKGROUND ART

In an optical transmission system such as a passive optical network (abbreviation: PON), a station-side device and a plurality of subscriber-side devices perform communication through optical transmission lines. In the PON system, the station-side device is also referred to as an optical line terminal (abbreviation: OLT), and the subscriber-side devices are also referred to as optical network units (abbreviation: ONUs).

To each of the ONUs, a lower device, for example, a radio base station device for a portable terminal device is connected. Each lower device realizes synchronization of a time based on time information generated by the ONU to which the device is connected. Hence, each ONU connected to the OLT is required to synchronize with a time of the OLT that operates in synchronization with a time source such as a global positioning system (abbreviation: GPS).

A technology for synchronizing the time between the OLT and the ONU is disclosed, for example, in Patent Document 1. In the technology disclosed in Patent Document 1, a first time stamp indicating a time of a counter of the OLT and a round trip time (abbreviation: RTT) between the OLT and the ONU are notified from the OLT to the ONU. A second time stamp showing a time of a counter of the ONU is corrected based on the notified RTT.

### PRIOR ART DOCUMENT

### Patent Document

Patent Document 1: Japanese Patent Application Laid-Open No. 2009-5070

### SUMMARY OF INVENTION

### Problems to be Solved by the Invention

As a technology for saving electric power of the ONU, there is a cyclic sleep mode. The cyclic sleep mode is an operation mode of turning a power supply of a photoelectric conversion unit of the ONU to an OFF state when no traffic is present. The ONU receives a downlink signal, which comes from the OLT, by the photoelectric conversion unit, and accordingly, when the power supply of the photoelectric conversion unit of the ONU is turned to the OFF state in the cyclic sleep mode, the ONU becomes incapable of receiving the downlink signal sent from the OLT.

In the technology disclosed in Patent Document 1 mentioned above, the first stamp and the RTT are notified to the ONU by the downlink signal sent from the OLT, and the synchronization of the time is realized. Hence, when the cyclic sleep mode comes, and the ONU becomes incapable of receiving the downlink signal sent from the OLT, the ONU cannot acquire the first time stamp and the RTT, and cannot realize the synchronization of the time.

As a result thereof, an error of time between an ONU local timer corresponding to the counter of the ONU and an OLT local timer corresponding to the counter of the OLT is increased with an elapse of time, and there occurs a case where accurate time information cannot be generated.

An object of the present invention is to provide a subscriber-side device, which can generate the accurate time information and can synchronize a time with other device even if a power supply of a portion that receives the downlink signal is in the OFF state, and to provide an optical transmission system including the same.

### Means for Solving the Problems

A subscriber-side device of the present invention is a subscriber-side device provided in an optical transmission system in which a station-side device and a plurality of the subscriber-side devices perform communication through optical transmission lines, the subscriber-side device including: a receiving unit that receives a downlink signal to be transmitted from the station-side device; a synchronization clock generation unit that generates a synchronization clock signal based on the downlink signal received by the receiving unit, the synchronization clock signal being synchronized with the station-side device; a free-running clock generation unit that generates a free-running clock signal serving as a reference at a time when the subscriber-side device operates independently of the station-side device; a free-running time generation unit that generates free-running time information based on the free-running clock signal, the free-running time information indicating a current time; a frequency deviation measurement unit that measures a frequency deviation between the synchronization clock signal and the free-running clock signal; a correction information generation unit that, based on the frequency deviation, generates correction information for correcting the free-running time information; a time information management unit that corrects and outputs the free-running time information based on the correction information; and a downlink signal interruption detection unit that detects that the receiving unit is in a signal interruption state of being incapable of recognizing or receiving the downlink signal, characterized in that, in the case where it is detected that the receiving unit is in the signal interruption state by the downlink signal interruption detection unit, the time information management unit corrects and outputs the free-running time information based on the correction information generated, before it is detected that the receiving unit is in the signal interruption state, by the correction information generation unit.

An optical transmission system of the present invention is an optical transmission system in which a station-side device and a plurality of subscriber-side devices perform communication through optical transmission lines, characterized in that the subscriber-side device is the subscriber-side device of the present invention.

### Effects of the Invention

In accordance with the subscriber-side device of the present invention, the downlink signal to be transmitted from the station-side device is received by the receiving unit. Based on the received downlink signal, the synchronization clock signal synchronized with the station-side device is generated by the synchronization clock generation unit. Moreover, by the free-running clock generation unit, the free-running clock signal serving as a reference at the time when the subscriber-side device operates independently of the station-side device is generated. Based on the generated free-running clock signal, the free-running time information indicating the current time is generated by the free-running time generation unit. The frequency deviation between the synchronization clock signal and the free-running clock signal is measured by the frequency measurement unit, and the correction information for correcting the free-running time information is generated by the correction information generation unit based on the measured frequency deviation. Based on the generated correction information, the free-running time information is corrected and outputted by the time information management unit.

In the case where it is detected that the downlink signal is in the signal interruption state by the downlink signal interruption detection unit, the free-running time information is corrected and outputted based on the correction information generated by the correction information generation unit before it is detected that the downlink signal is in the signal interruption state, by the time information management unit. In this way, no matter whether or not the downlink signal may be present, accurate free-running time information can be generated as the time information of the device, and accordingly, even if the power supply of the receiving unit is in the OFF state, the time can be synchronized with other device. Hence, even at the time of a state where a time synchronization function is being used though user traffic does not flow, the power supply of the receiving unit can shift to the cyclic sleep mode of being turned to the OFF state, and accordingly, the electric power saving of the subscriber-side device can be achieved.

In accordance with the optical transmission system of the present invention, the optical transmission system is configured by including the subscriber-side device capable of achieving the electric power saving as mentioned above. Hence, the electric power saving of the optical transmission system can be achieved.

Objects, features, aspects and advantages of the present invention will be more apparent by the following detailed description and the accompanying drawings.

### BRIEF DESCRIPTION OF DRAWINGS

FIG. 1 is a block diagram showing a configuration of an optical transmission system 10 of an underlying technology of the present invention.

FIG. 2 is a block diagram showing a configuration of an OLT 11 in the optical transmission system 10.

FIG. 3 is a block diagram showing a configuration of an ONU 12 in the optical transmission system 10.

FIG. 4 is a view showing a time synchronization frame (TSF).

FIG. 5 is a block diagram showing a configuration of an ONU 1 in a first embodiment of the present invention.

FIG. 6 is a flowchart showing a processing procedure regarding time correction processing in the ONU 1 in the first embodiment of the present invention.

FIG. 7 is a block diagram showing a configuration of an ONU 2 in a second embodiment of the present invention.

FIG. 8 is a flowchart showing a processing procedure regarding time information output processing in the ONU 2 of the second embodiment of the present invention.

FIG. 9 is a block diagram showing a configuration of an ONU 3 in a third embodiment of the present invention.

FIG. 10 is a flowchart showing a processing procedure regarding processing in the case where the ONU 3 in the third embodiment of the present invention is not in a sleep state.

FIG. 11 is a flowchart showing a processing procedure regarding processing in the case where the ONU 3 in the third embodiment of the present invention is in the sleep state.

### DESCRIPTION OF EMBODIMENTS

<Underlying Technology>

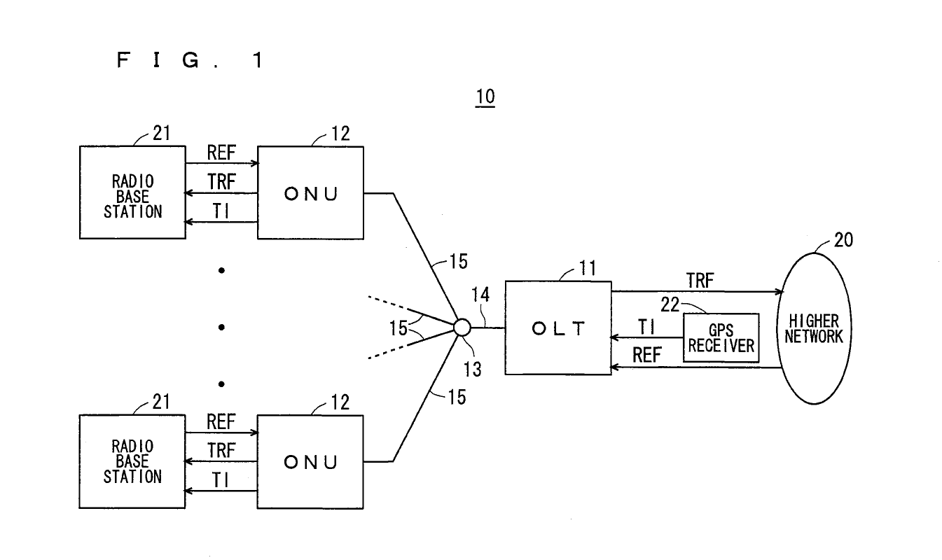

Before a description is made of the optical transmission system of the present invention, a description is made of an optical transmission system of an underlying technology of the present invention. FIG. 1 is a block diagram showing a configuration of an optical transmission system 10 of the underlying technology of the present invention. The optical transmission system 10 of the underlying technology is a passive optical network (abbreviation: PON) system. In the following description, there is a case where the optical transmission system 10 is referred to as “PON system 10”. In the PON system 10, a single station-side device 11 and a plurality of subscriber-side devices 12 perform communication through optical fibers 14 and 15.

The PON system 10 is configured by including the single station-side device 11, the plurality of subscriber-side devices 12, an optical coupler 13, and the optical fibers 14 and 15. The station-side device 11 corresponds to a master station device in the PON system 10, and is installed, for example, in a telephone office and the like. The subscriber-side devices 12 correspond to slave station devices in the PON system 10, and are installed, for example, in subscriber's homes and the like.

In the PON system 10, the station-side device 11 is also referred to as an optical line terminal (abbreviation: OLT), and the subscriber-side devices 12 are also referred to as optical network units (abbreviation: ONUs). In the following description, there is a case where the station-side device 11 is referred to as “OLT 11” and each of the subscriber-side devices 12 is referred to as “ONU 12”. There is a case where, between the optical fibers 14 and 15, the optical fiber 14 to be connected to the OLT 11 is referred to as “OLT-side optical fiber 14”, and the optical fiber 15 to be connected to the ONU 12 is referred to as “ONU-side optical fiber 15”.

The OLT 11 is connected to a higher network 20, for example, the Internet. The OLT 11 is connected to the higher network 20, for example, through a router. The OLT 11 is connected to the optical coupler 13 through the OLT-side optical fiber 14. The optical coupler 13 is an optical passive element, which is connected to a plurality of the ONU-side optical fibers 15, and performs branching and coupling for an optical signal to be transferred between the OLT-side optical fiber 14 and the ONU-side optical fibers 15. The ONUs 12 are individually connected to the respective ONU-side optical fibers 15.

As described above, the OLT 11 and the plurality of ONUs 12 are connected to each other so as to be optically communicable with each other through the optical coupler 13 and the optical fibers 14 and 15. To each of the ONUs 12, a lower device, for example, a radio base station device (hereinafter, referred to as “radio base station” in some case) 21 for a portable terminal device is connected.

The OLT 11 transmits a frame (hereinafter, referred to as “received frame” or “REF” in some case), which is received from the higher network 20, to each of the ONUs 12 through the optical coupler 13 and the optical fibers 14 and 15. Moreover, the OLT 11 transmits a frame, which is received from each of the ONUs 12, as a frame (hereinafter, referred to as “transmitted frame” or “TRF” in some case), which is to be transmitted, to the higher network 20. Moreover, the OLT 11 is connected, for example, to a global positioning system (abbreviation: GPS) receiver 22, and acquires time information (hereinafter, referred to as “TI” in some case), which indicates a current time, from the GPS receiver 22.

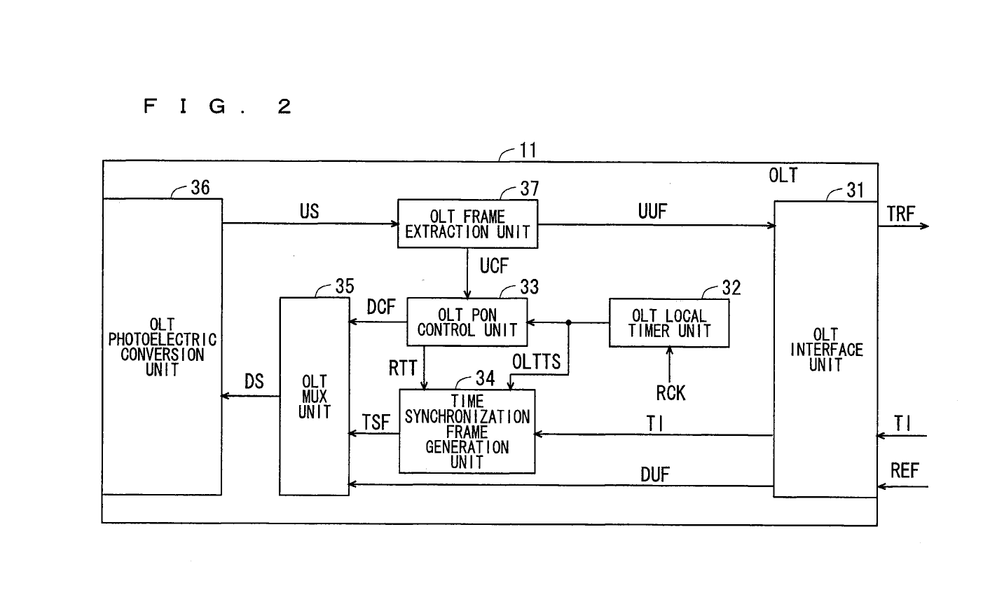

FIG. 2 is a block diagram showing a configuration of the OLT 11 in the optical transmission system 10. The OLT 11 is configured by including an OLT interface unit 31, an OLT local timer unit 32, an OLT PON control unit 33, a time synchronization frame generation unit 34, an OLT multiplex (abbreviation: MUX) unit 35, an OLT photoelectric conversion unit 36, and an OLT frame extraction unit 37.

The OLT interface unit 31 gives the received frame (REF), which is received from the higher network 20, as a user frame, to the OLT MUX unit 35. The user frame stands for a communication frame, which is to be transmitted/received between the portable terminal device connected to the radio base station device 21 as the lower device of the ONU 12 and a device connected to the higher network 20. The user frame which the OLT interface unit 31 gives to the OLT MUX unit 35 is a user frame (hereinafter, referred to as “downlink user frame” or “DUF”) in a downlink direction from the OLT 11 to the ONU 12.

Moreover, the OLT interface unit 31 transmits the user frame, which is to be given from an OLT frame extraction unit 37 to be described later, as the transmitted frame (TRF) to the higher network 20. The user frame which the OLT interface unit 31 is given from the OLT frame extraction unit 37 is a user frame (hereinafter, referred to as “uplink user frame” or “UUF”) in an uplink direction from the ONU 12 to the OLT 11.

For example, the OLT interface unit 31 receives the time information (TI) to be transmitted from the GPS receiver 22. The OLT interface unit 31 gives the received time information (TI) to the time synchronization frame generation unit 34.

The OLT local timer unit 32 has an OLT counter, which counts up in synchronization with a reference clock signal (hereinafter, referred to as “RCK” in some case) to be given from an outside. For example, the reference clock signal (RCK) is a clock signal acquired from a locked oscillator which the OLT 11 has or from the GPS receiver 22 or the like. In an EPON (Ethernet (registered trademark) PON), a 32-bit counter, which counts up every 16 ns, is used as the OLT counter. The OLT local timer unit 32 counts up the OLT counter autonomously, sets a value of the OLT counter as an OLT time stamp (hereinafter, referred to as “OLTTS” in some case), and gives the OLTTS to the OLT PON control unit 33 and the time synchronization frame generation unit 34.

The OLT PON control unit 33 performs measurement for a round trip time (RTT). The OLT PON control unit 33 measures the RTT from a difference between a time stamp of an ONU local timer unit 49 in the ONU 12, which will be described later, and the OLT time stamp (OLTTS) to be given from the OLT local timer unit 32. The time stamp of the ONU local timer unit 49 is stored in an uplink PON control frame (hereinafter, referred to as “UCF” in some case) to be given from the OLT frame extraction unit 37 to be described later. The uplink PON control frame (UCF) is a PON control frame in the uplink direction from the ONU 12 to the OLT 11. The OLT PON control unit 33 gives the measured RTT to the time synchronization frame generation unit 34.

The OLT PON control unit 33 generates a downlink PON control frame (hereinafter, referred to as “DCF” in some case”), which is a PON control frame in the downlink direction from the OLT 11 to the ONU 12, by using the uplink PON control frame (UCF) to be given from the OLT frame extraction unit 37. The OLT PON control unit 33 gives the generated downlink PON control frame (DCF) to the OLT MUX unit 35.

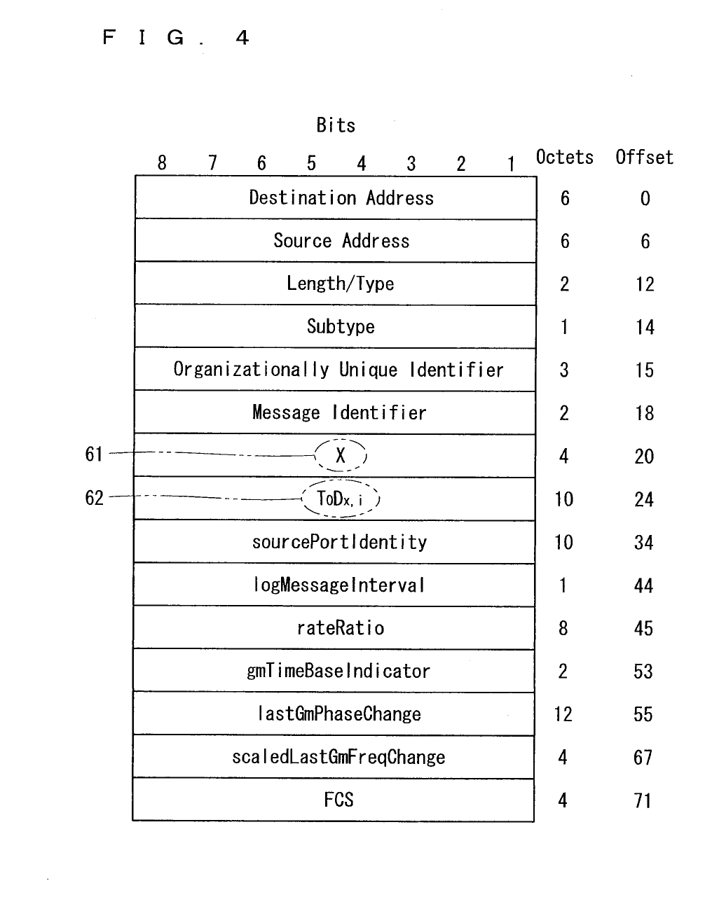

The time synchronization frame generation unit 34 generates a time synchronization frame (hereinafter, referred to as “TSF” in some case) based on the time information (TI) to be given from the OLT interface unit 31, on the OLT time stamp (OLTTS) to be given from the OLT local timer unit 32, and on the RTT to be given from the OLT PON control unit 33. For example, the time synchronization frame (TSF) has a configuration shown in FIG. 4 to be described later. The time synchronization frame generation unit 34 gives the generated time synchronization frame (TSF) to the OLT MUX unit 35. For example, at a time interval of once a second, the time synchronization frame generation unit 34 gives the time synchronization frame (TSF) to the OLT MUX unit 35.

The OLT MUX unit 35 multiplexes the downlink PON control frame (DCF) to be given from the OLT PON control unit 33, the time synchronization frame (TSF) to be given from the time synchronization frame generation unit 34, and the downlink user frame (DUF) to be given from the OLT interface unit 31, and generates a downlink signal (hereinafter, referred to as “DS” in some case”). The OLT MUX unit 35 gives the generated downlink signal (DS) to the OLT photoelectric conversion unit 36.

The OLT photoelectric conversion unit 36 performs mutual conversion between an electric signal and an optical signal. Specifically, the OLT photoelectric conversion unit 36 converts the downlink signal (DS), which is to be given from the OLT MUX unit 35, into an optical signal, and transmits the optical signal to the ONU 12 through the optical coupler 13. The downlink signal (DS) includes the downlink user frame (DUF), the downlink PON control frame (DCF) and the time synchronization frame (TSF).

Moreover, the OLT photoelectric conversion unit 36 converts an optical signal sent from the ONU 12, which is received through the optical coupler 13, into an uplink signal (hereinafter, referred to as “US” in some case) as an electric signal, and give the electric signal to the OLT frame extraction unit 37. The uplink signal (US) includes the uplink user frame (UUF) and the uplink PON control frame (UCF).

The OLT frame extraction unit 37 extracts the uplink PON control frame (UCF) from an inside of the uplink signal (US) to be given from the OLT photoelectric conversion unit 36. The OLT frame extraction unit 37 gives the extracted uplink PON control frame (UCF) to the OLT PON control unit 33. Moreover, the OLT frame extraction unit 37 gives the uplink user frame (UUF) to the OLT interface unit 31.

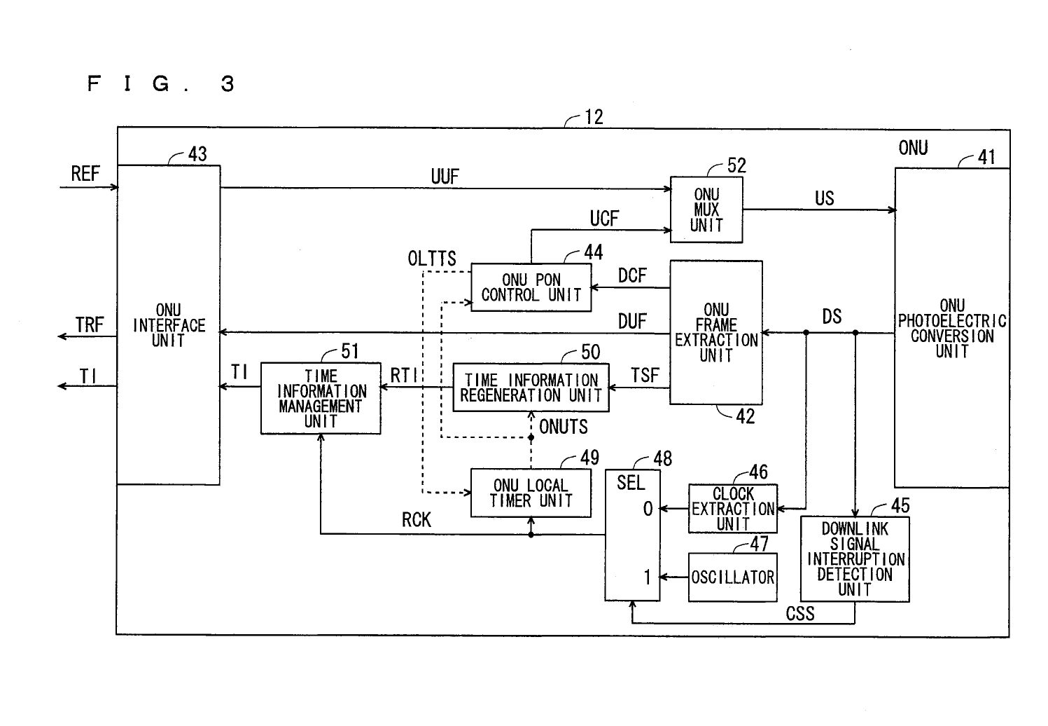

FIG. 3 is a block diagram showing a configuration of the ONU 12 in the optical transmission system 10. The ONU 12 is configured by including an ONU photoelectric conversion unit 41, an ONU frame extraction unit 42, an ONU interface unit 43, an ONU PON control unit 44, a downlink signal interruption detection unit 45, a clock extraction unit 46, an oscillator 47, a selector (abbreviation: SEL) 48, the ONU local timer unit 49, a time information regeneration unit 50, a time information management unit 51 and an ONU MUX unit 52.

The ONU photoelectric conversion unit 41 performs mutual conversion between an electric signal and an optical signal. Specifically, the ONU photoelectric conversion unit 41 converts the downlink signal, which is the optical signal sent from the OLT 11, the optical signal being received through the optical coupler 13, into a downlink signal (DS) that is an electric signal, and gives the downlink signal (DS) to the ONU frame extraction unit 42, the downlink signal interruption detection unit 45 and the clock extraction unit 46. The downlink signal (DS) includes a downlink user frame (DUF), a downlink PON control frame (DCF), and a time synchronization frame (TSF). The ONU photoelectric conversion unit 41 corresponds to a receiving unit.

From the downlink signal (DS) to be given from the ONU photoelectric conversion unit 41, the ONU frame extraction unit 42 identifies the time synchronization frame (TSF), the downlink PON control frame (DCF) and the downlink user frame (DUF), and extracts the individual frames. The ONU frame extraction unit 42 gives the extracted time synchronization frame (TSF) to the time information regeneration unit 50. The ONU frame extraction unit 42 gives the extracted downlink PON control frame (DCF) to the ONU PON control unit 44. The ONU frame extraction unit 42 gives the extracted downlink user frame (DUF) to the ONU interface unit 43.

The ONU interface unit 43 transmits the downlink user frame (DUF), which is to be given from the ONU frame extraction unit 42, as the transmitted frame (TRF) to the radio base station 21 that is a lower device of the ONU 12.

The ONU PON control unit 44 extracts the OLT time stamp (OLTTS) from the downlink PON control frame (DCF) to be given from the ONU frame extraction unit 42. The ONU PON control unit 44 gives the extracted OLT time stamp (OLTTS) to the ONU local timer unit 49.

The ONU PON control unit 44 generates the uplink PON control frame (UCF) by using the downlink PON control frame (DCF) to be given from the ONU frame extraction unit 42. The ONU PON control unit 44 gives the generated uplink PON control frame (UCF) to the ONU MUX unit 52.

The downlink signal interruption detection unit 45 detects that the downlink signal (DS) to be given from the ONU photoelectric conversion unit 41 is in a signal interruption state. The signal interruption state refers to a state where the ONU photoelectric conversion unit 41 cannot recognize or receive the downlink signal (DS). For example, in the case where a signal level of the downlink signal (DS) sent from the OLT 11 is small, the ONU photoelectric conversion unit 41 turns to a state of being incapable of recognizing the downlink signal (DS). For example, the signal interruption state occurs by the fact that the OLT-side optical fiber 14 that connects the OLT 11 and the optical coupler 13 to each other or the ONU-side optical fiber 15 that connects the ONU 12 and the optical coupler 13 to each other is damaged.

By confirming an input state of the downlink signal (DS), the downlink signal interruption detection unit 45 detects that the downlink signal (DS) is in the signal interruption state. For example, “to confirm the input state of the downlink signal (DS)” refers to confirming whether or not the downlink signal (DS) is inputted or whether or not the signal level of the downlink signal (DS) is equal to or less than a predetermined threshold value.

As a method for detecting, by the downlink signal interruption detection unit 45, that the downlink signal (DS) is in the signal interruption state, for example, there are two methods, which are (1) and (2) shown below.

(1) In the case where the signal level of the downlink signal (DS), which is inputted to the ONU 12, is equal to or less than the predetermined threshold value, it is detected that the downlink signal (DS) is in the signal interruption state.

(2) In the case where the clock signal cannot be extracted from the downlink signal (DS), it is detected that the downlink signal (DS) is in the signal interruption state.

In the detection method of (1) described above, the downlink signal interruption detection unit 45 measures the signal level of the downlink signal (DS) based on the downlink signal (DS) to be given from the ONU photoelectric conversion unit 41. In the case where the measured signal level of the downlink signal (DS) is equal to or less than the predetermined threshold value, the downlink signal interruption detection unit 45 detects that the downlink signal (DS) is in the signal interruption state.

In the detection method of (2) described above, in the case where an unillustrated phase locked loop (abbreviation: PLL) is not locked, the downlink signal interruption detection unit 45 detects that the downlink signal (DS) is in the signal interruption state. For example, in the case where the signal level is low, or in the case where a bit rate of data is out of a standard, or the like, a normal downlink signal (DS) is not inputted to the ONU photoelectric conversion unit 41. In this case, a downlink signal (DS), from which the clock signal cannot be extracted, is given from the ONU photoelectric conversion unit 41 to the downlink signal interruption detection unit 45. Hence, the downlink signal interruption detection unit 45 can detect that the downlink signal (DS) is in the signal interruption state by confirming whether or not the clock signal can be extracted from the downlink signal (DS).

Upon detecting that the downlink signal (DS) is not in the signal interruption state, the downlink signal interruption detection unit 45 gives the SEL 48 flag information, which indicates that the downlink signal (DS) is not in the signal interruption state, for example, a clock selection signal (hereinafter, referred to as “CSS”) including “0”. Upon detecting that the downlink signal (DS) is in the signal interruption state, the downlink signal interruption detection unit 45 gives the SEL 48 flag information, which indicates that the downlink signal (DS) is in the signal interruption state, for example, a clock selection signal (CSS) including “1”.

For example, by using a clock data recovery (abbreviation: CDR) technology, the clock extraction unit 46 extracts a clock signal (hereinafter, referred to as “OLT synchronization clock signal” in some case), which is synchronized with the OLT 11, from the downlink signal (DS) to be given from the ONU photoelectric conversion unit 41. Specifically, the OLT synchronization clock signal is a clock signal synchronized with the clock signal received from the locked oscillator which the OLT 11 has or from the GPS receiver 22 or the like.

For example, by using the unillustrated PLL, the clock extraction unit 46 adjusts a phase of the reference clock signal, which is a clock signal to be outputted from the locked oscillator provided in the ONU 12, and thereby extracts the OLT synchronization clock signal. The clock extraction unit 46 corresponds to a synchronization clock generation unit. The extraction of the OLT synchronization clock signal corresponds to generation of the OLT synchronization clock signal. The clock extraction unit 46 gives the extracted OLT synchronization clock signal to the SEL 48.

The oscillator 47 is a free-running clock signal source that generates a clock signal (hereinafter, referred to as “free-running clock signal” in some case) serving as a reference at the time when the ONU 12 operates independently of the OLT 11. The oscillator 47 corresponds to a free-running clock generation unit. The oscillator 47 gives the generated free-running clock signal to the SEL 48.

Based on a clock selection signal (CSS) including the flag information to be given from the downlink signal interruption detection unit 45, the SEL 48 selects the OLT synchronization clock signal to be given from the clock extraction unit 46 or the free-running clock signal to be given from the oscillator 47.

In the case where it is detected that the downlink signal (DS) is not in the signal interruption state by the downlink signal interruption detection unit 45, then to the SEL 48, “0” is given as the flag information from the downlink signal interruption detection unit 45. Upon being given “0” as the flag information from the downlink signal interruption detection unit 45, the SEL 48 gives the OLT synchronization clock signal, which is to be given from the clock extraction unit 46, as the reference clock signal (RCK) to the ONU local timer unit 49 and the time information management unit 51.

In the case where it is detected that the downlink signal (DS) is in the signal interruption state by the downlink signal interruption detection unit 45, then to the SEL 48, “1” is given as the flag information from the downlink signal interruption detection unit 45. Upon being given “1” as the flag information from the downlink signal interruption detection unit 45, the SEL 48 gives the free-running clock signal, which is to be given from the oscillator 47, as the reference clock signal (RCK) to the ONU local timer unit 49 and the time information management unit 51.

The ONU local timer unit 49 has an ONU counter, which counts up based on the OLT synchronization clock signal, which is to be given from the clock extraction unit 46 through the SEL 48, or on the free-running clock signal to be given from the oscillator 47. In the EPON, a 32-bit counter, which counts up every 16 ns, is used as the ONU counter.

The ONU local timer unit 49 is configured to merge a count value thereof with the OLT time stamp (OLTTS) upon being given the OLT time stamp (OLTTS) from the ONU PON control unit 44. Hence, when the ONU local timer unit 49 is in a state of being capable of receiving the downlink PON control frame (DCF), and is using the OLT synchronization clock signal, the count value counted up by the ONU local timer unit 49 indicates a difference value between a value of the OLT local timer and a value of a half (RTT/2) of the RTT, that is, a value of {OLT local timer−(RTT/2)}.

The ONU local timer unit 49 sets the count value at an ONU time stamp (hereinafter, referred to as “ONUTS” in some case”, and gives the ONUTS to the time information regeneration unit 50 and the ONU PON control unit 44.

The time information regeneration unit 50 regenerates current time information from the ONU time stamp (ONUTS), which is to be given from the ONU local timer unit 49, from time information extracted from the time synchronization frame (TSF), which is to be given from the ONU frame extraction unit 42, and from the OLT time stamp (OLTTS). The time information regeneration unit 50 gives regenerated time information (hereinafter, referred to as “RTI” in some case), which represents the regenerated time information, to the time information management unit 51.

The time information management unit 51 has a counter, which indicates the current time by counting up by the OLT synchronization clock signal to be given from the clock extraction unit 46 through the SEL 48, or the free-running clock signal to be given from the oscillator 47. The time information management unit 51 sets the counter for the regenerated time information (RTI) to be given from the time information regeneration unit 50. At predetermined timing, for example, when digits of a second after the decimal point become “0”, the time information management unit 51 gives time information (TI), which is the count value, to the ONU interface unit 43.

The ONU interface unit 43 transmits the time information (TI), which is given from the time information management unit 51, to the radio base state 21 that is the lower device of the ONU 12. Moreover, the ONU interface unit 43 gives the received frame (REF), which is received from the radio base station 21 that is the lower device of the ONU 12, as the uplink user frame (UUF) to the ONU MUX unit 52.

The ONU MUX unit 52 multiplexes the uplink user frame (UUF), which is to be given from the ONU interface unit 43, and the uplink PON control frame (UCF), which is to be given from the ONU PON control unit 44, and generates an uplink signal (US). The ONU MUX unit 52 gives the generated uplink signal (US) to the ONU photoelectric conversion unit 41.

The ONU photoelectric conversion unit 41 converts the uplink signal (US), which is to be given from the ONU MUX unit 52, into an optical signal, and transmits the optical signal to the OLT 11 through the optical coupler 13.

FIG. 4 is a view showing the time synchronization frame (TSF). The time synchronization frame (TSF) is generated by the time synchronization frame generation unit 34. The time synchronization frame (TSF) shown in FIG. 4 is a frame that stores information in which the time information and the local timer of the OLT 11 are associated with each other.

In the time synchronization frame (TSF), there are included: an OLT time stamp (OLTTS) 61 at the time when the time information is received; and time information (TI) 62 in which the RTT is corrected. The time information 62 in which the RTT is corrected becomes a sum of the received time information and the value of the half (RTT/2) of the RTT.

When a power supply of the ONU photoelectric conversion unit 41 of the ONU 12 is turned to an OFF state in the cyclic sleep mode, the ONU 12 becomes incapable of receiving the downlink signal (DS) from the OLT 11.

In the conventional technology, for example, in the technology disclosed in Patent Document 1 mentioned above, by the downlink signal sent from the OLT 11, the first time stamp and the RTT are notified to the ONU 12, and the synchronization of the time is realized. Hence, when the cyclic sleep mode comes, and the ONU 12 becomes incapable of receiving the downlink signal sent from the OLT 11, the first time stamp and the RTT cannot be acquired, and it becomes impossible to realize the synchronization of the time.

As a result thereof, an error of the time between the ONU local timer unit 49 and the OLT local timer unit 32 is increased with an elapse of the time, and there occurs a case where accurate time information cannot be generated.

In this connection, in the optical transmission system of the present invention, configurations to be shown in the following respective embodiments are employed in order to generate the accurate time information. An optical transmission system of each of the following respective embodiments is a PON system in a similar way to the optical transmission system 10 of the underlying technology. A configuration of an OLT that constitutes the PON system of each of the embodiments is the same as the configuration of the OLT 11 in the optical transmission system 10 of the underlying technology, and accordingly, is added with the same reference numerals, and illustration and description thereof are omitted.

### First Embodiment

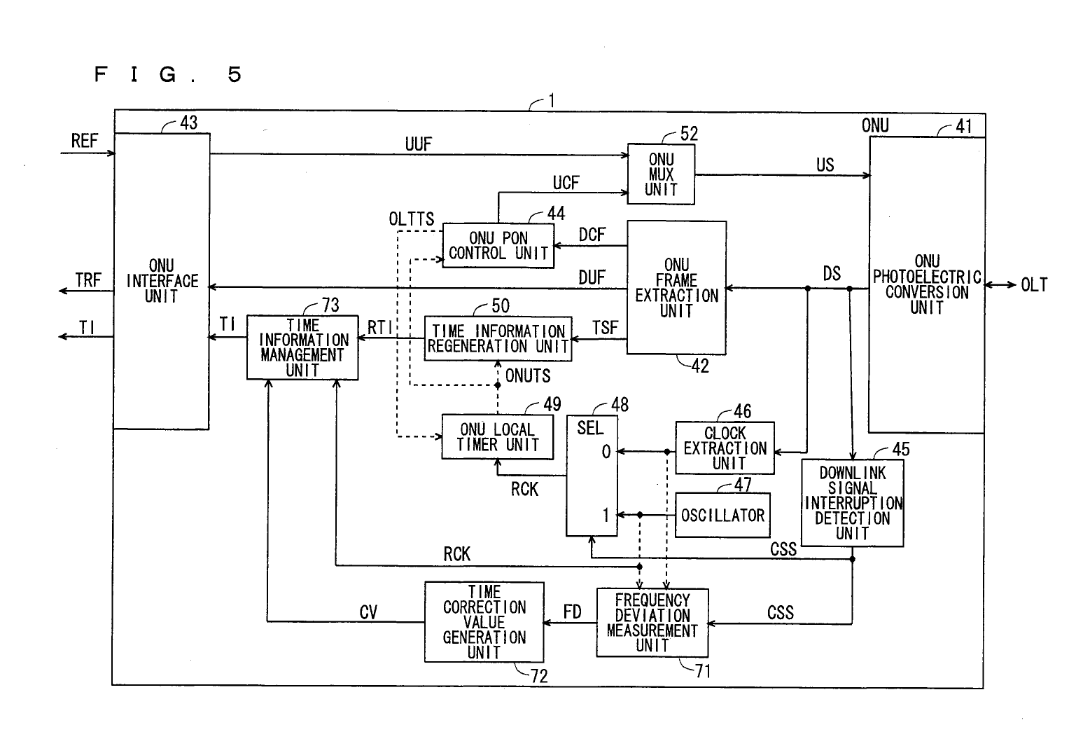

FIG. 5 is a block diagram showing a configuration of an ONU 1 of a first embodiment of the present invention. A configuration of the ONU 1 shown in FIG. 5 resembles the configuration of the ONU 12 of the underlying technology, which is shown in FIG. 3 mentioned above, and accordingly, a description is made only of different portions, and corresponding portions are added with the same reference numerals, and a common description is omitted.

The ONU 1 is configured by including an ONU photoelectric conversion unit 41, an ONU frame extraction unit 42, an ONU interface unit 43, an ONU PON control unit 44, a downlink signal interruption detection unit 45, a clock extraction unit 46, an oscillator 47, a SEL 48, an ONU local timer unit 49, a time information regeneration unit 50, an ONU MUX unit 52, a frequency deviation measurement unit 71, a time correction value generation unit 72 and a time information management unit 73.

Upon detecting that the downlink signal is not in the signal interruption state, the downlink signal interruption detection unit 45 gives the flag information, which indicates that the downlink signal is not in the signal interruption state, for example, the clock selection signal (CSS), which includes “0”, to the SEL 48 and the frequency deviation measurement unit 71. Upon detecting that the downlink signal is in the signal interruption state, the downlink signal interruption detection unit 45 gives the flag information, which indicates that the downlink signal is in the signal interruption state, for example, the clock selection signal (CSS), which includes “1”, to the SEL 48 and the frequency deviation measurement unit 71.

The clock extraction unit 46 gives the extracted OLT synchronization clock signal to the SEL 48 and the frequency deviation measurement unit 71. The oscillator 47 gives the generated free-running clock signal to the SEL 48 and the frequency deviation measurement unit 71. Moreover, the oscillator 47 gives the generated free-running clock signal as the reference clock signal (RCK) to the time information management unit 73.

At the time when the downlink signal is not in the signal interruption state, the frequency deviation measurement unit 71 measures a frequency deviation (hereinafter, referred to as “FD” in some case) between the OLT synchronization clock signal, which is to be given from the clock extraction unit 46, and the free-running clock signal, which is to be given from the oscillator 47. Here, “the time when the downlink signal is not in the signal interruption state” is a time when a link between the OLT 11 and the ONU 1 is established, and the flag information included in the clock selection signal (CSS) to be given from the downlink signal interruption detection unit 45 is “0”. Specifically, the frequency deviation measurement unit 71 calculates, as the frequency deviation (FD), a difference value between the count value of the counter driven by the OLT synchronization clock signal and the count value of the counter driven by the free-running clock signal.

At the time when the downlink signal is in the signal interruption state, the frequency deviation measurement unit 71 holds a measurement result of the frequency deviation (FD) measured last time. Here, “the time when the downlink signal is in the signal interruption state” is a time when the flag information included in the clock selection signal (CSS) to be given from the downlink signal interruption detection unit 45 is “1”. The frequency deviation measurement unit 71 gives a measurement result of the measured frequency deviation (FD) to the time correction value generation unit 72.

Based on the measurement result of the frequency deviation (FD), which is to be given from the frequency deviation measurement unit 71, the time correction value generation unit 72 generates a time correction value (CV) per unit time. The time correction value generation unit 72 corresponds to a correction information generation unit. The time correction value (CV) corresponds to correction information for correcting free-running time information that is a count value of the time information management unit 73 to be described later. The time correction value generation unit 72 gives the generated time correction value (CV) to the time information management unit 73.

In the present embodiment, the time information management unit 73 has a counter, which indicates the current time by counting up by the free-running clock signal to be given from the oscillator 47. The time information management unit 73 corresponds to a free-running time information generation unit. A value of the counter of the time information management unit 73 corresponds to the free-running time information representing the current time. The fact that the counter of the time information management unit 73 counts up by the free-running clock signal corresponds to the fact that the free-running time information is generated based on the free-running clock signal.

The time information management unit 73 sets the counter for the regenerated time information (RTI) to be given from the time information regeneration unit 50. Moreover, based on the time correction value (CV) to be given from the time correction value generation unit 72 per unit time, for example, every 1 ms, the time information management unit 73 corrects the count value of the counter. At predetermined timing, for example, when digits of a second after the decimal point become “0”, the time information management unit 73 outputs the free-running time information, which is the corrected count value, and gives the free-running time information to the ONU interface unit 43.

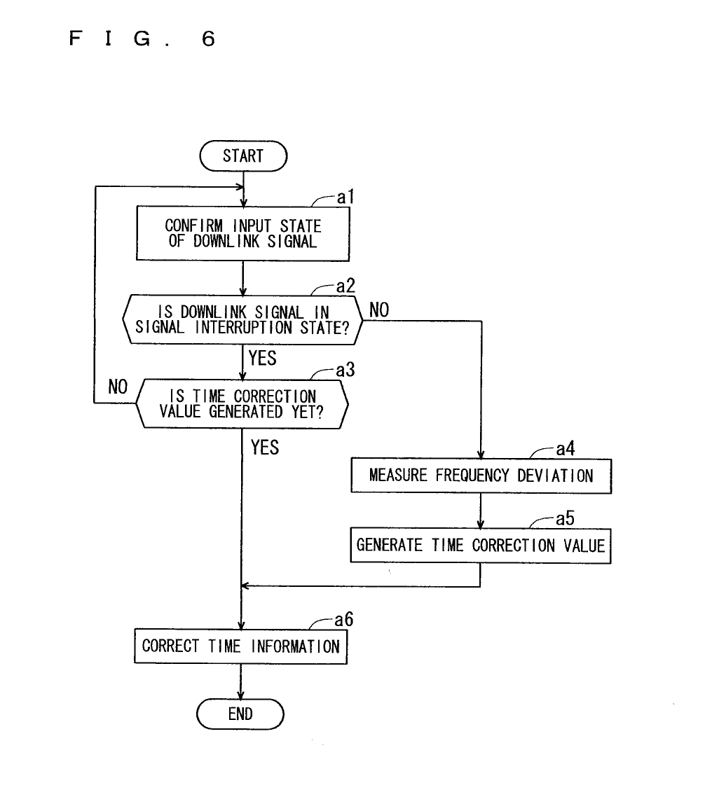

FIG. 6 is a flowchart showing a processing procedure regarding time correction processing in the ONU 1 of the first embodiment of the present invention. The respective pieces of processing, which are shown in FIG. 6, are executed by the downlink signal interruption detection unit 45, frequency deviation measurement unit 71, time correction value generation unit 72 and time information management unit 73 of the ONU 1. When electric power is supplied to the ONU 1 from an unillustrated power supply, the processing shown in the flowchart of FIG. 6 is started, and shifts to Step al.

The ONU photoelectric conversion unit 41 has an unillustrated power supply capable of switching between an ON state and OFF state independently of the power supply that supplies electric power to the whole of the ONU 1. The fact that the power supply of the ONU photoelectric conversion unit 41 is to be turned to the ON state refers to the fact that the power supply is to be turned to a state of supplying the electric power to the ONU photoelectric conversion unit 41. The fact that the power supply of the ONU photoelectric conversion unit 41 is to be turned to the OFF state refers to the fact that the power supply is to be turned to a state of stopping the supply of the electric power to the ONU photoelectric conversion unit 41. When the electric power is supplied to the ONU 1, and the ONU 1 is turned to the ON state, the power supply of the ONU photoelectric conversion unit 41 is switched from the OFF state to the ON state.

In Step a1, the downlink signal interruption detection unit 45 confirms an input state of the downlink signal. Specifically, the downlink signal interruption detection unit 45 confirms whether or not the downlink signal is inputted, or whether or not the signal level of the downlink signal is equal to or less than a predetermined threshold value. After the input state of the downlink signal is confirmed, the processing shifts to Step a2.

In Step a2, the downlink signal interruption detection unit 45 determines whether or not the downlink signal is in the signal interruption state based on the input state of the downlink signal, which is confirmed in Step al. In the case where it is determined in Step a2 that the downlink signal is in the signal interruption state, that is, in the case where it is determined that the downlink signal is in the signal interruption state by the downlink signal interruption detection unit 45, the processing shifts to Step a3, and in the case where it is determined that the downlink signal is not in the signal interruption state, the processing shifts to Step a4.

In Step a3, the time correction value generation unit 72 determines whether or not the time correction value (CV) is already generated. In the case where it is determined in Step a3 that the time correction value (CV) is already generated, the processing shifts to Step a6, and in the case where it is determined therein that the time correction value (CV) is not generated yet, the processing returns to Step a1, and the above-mentioned processing is repeated.

In Step a4, the frequency deviation measurement unit 71 measures the frequency deviation (FD) as mentioned above. After the frequency deviation (FD) is measured, the processing shifts to Step a5.

In Step a5, the time correction value generation unit 72 generates the time correction value (CV) as mentioned above. After the time correction value (CV) is generated, the processing shifts to Step a6.

In the case where the processing shifts from Step a3 to Step a6, then in Step a6, the time information management unit 73 corrects the free-running time information based on the time correction value (CV) generated before it is determined in Step a2 that the downlink signal is in the signal interruption state. In other words, the time information management unit 73 corrects the value of the counter, which manages the free-running time information, based on the time correction value (CV) generated before it is determined in Step a2 that the downlink signal is in the signal interruption state.

In the case where the processing shifts from Step a5 to Step a6, then in Step a6, the time information management unit 73 corrects the free-running time information based on the time correction value (CV) generated in Step a5. In other words, the time information management unit 73 corrects the value of the counter, which manages the free-running time information, based on the time correction value (CV) generated in Step a5. After the processing for correcting the time information is ended, all of the processing procedure is ended.

As described above, in the ONU 1 of the present embodiment, the time information management unit 73, which manages the current time, is operated by the free-running clock signal of the ONU 1, measures the frequency deviation (FD) per unit time, and corrects the time correction value (CV). Specifically, in the case where it is determined in Step a2 that the downlink signal is not in the signal interruption state, the time information management unit 73 measures the frequency deviation (FD) in Step a4, and corrects the time correction value (CV) in Step a5. Then, in the case where it is determined in Step a2 that the downlink signal is in the signal interruption state, the time information management unit 73 corrects and outputs the free-running time information based on the time correction value (CV) generated before it is detected that the downlink signal is in the signal interruption state.

The ONU 1 of the present embodiment is configured as described above, and accordingly, no matter whether or not the downlink signal may be present, the accurate free-running time information can be generated as the time information of the device. In this way, even if the power supply of the ONU photoelectric conversion unit 41 is in the OFF state, the ONU 1 of the present embodiment can realize the synchronization of the time with other device, for example, other ONU 12 or the OLT 11.

In other words, even in a state where the time synchronization function is being used though user traffic does not flow, the ONU 1 of the present embodiment can shift the power supply of the ONU photoelectric conversion unit 41 to the cyclic sleep mode of turning the power supply to the OFF state. Hence, electric power saving of the ONU 1 can be achieved. Here, the user traffic refers to traffic between the portable terminal device, which is to be connected to the radio base station device 21 that is the lower device of the ONU 1, and the device to be connected to the higher network 20.

The PON system of the present embodiment is configured by including the ONU 1 as described above, which is capable of achieving the electric power saving. Hence, in the present embodiment, the electric power saving of the PON system can be achieved.

### Second Embodiment

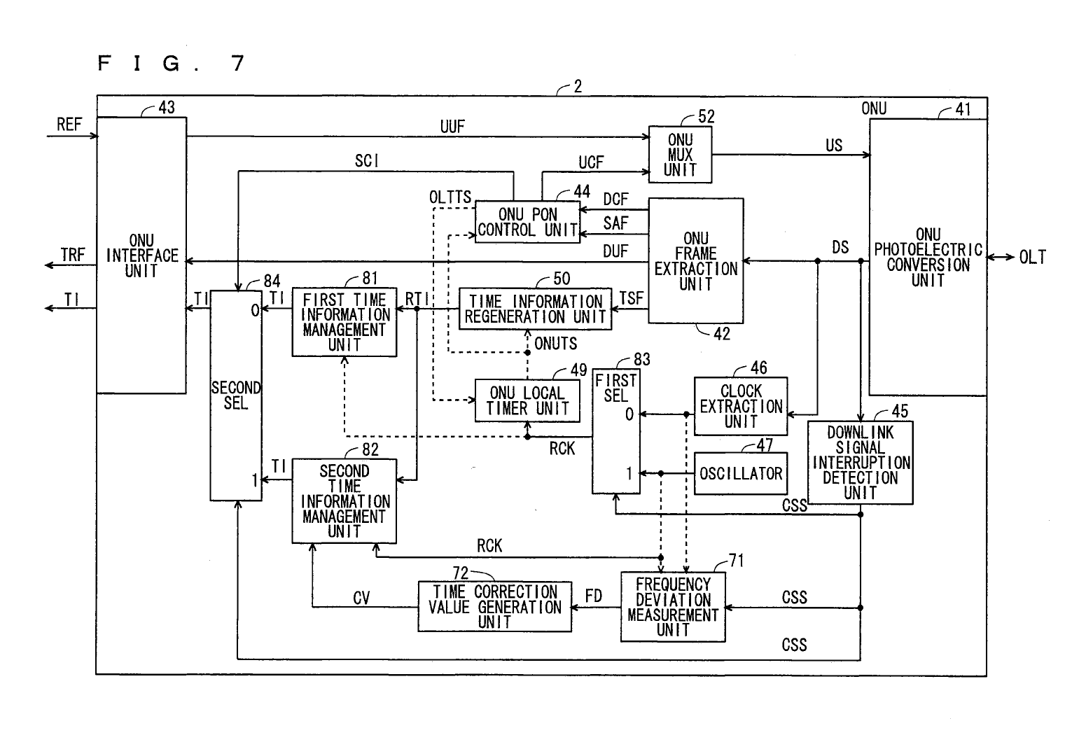

FIG. 7 is a block diagram showing a configuration of an ONU 2 in a second embodiment of the present invention. A configuration of the ONU 2 of the present embodiment, which is shown in FIG. 7, resembles the configuration of the ONU 1 of the first embodiment, which is shown in FIG. 5 mentioned above, and accordingly, a description is made only of different portions, and corresponding portions are added with the same reference numerals, and a common description is omitted.

The ONU 2 of the present embodiment is configured by including an ONU photoelectric conversion unit 41, an ONU frame extraction unit 42, an ONU interface unit 43, an ONU PON control unit 44, a downlink signal interruption detection unit 45, a clock extraction unit 46, an oscillator 47, an ONU local timer unit 49, a time information regeneration unit 50, an ONU MUX unit 52, a frequency deviation measurement unit 71, a time correction value generation unit 72, a first time information management unit 81, a second time information management unit 82, a first SEL 83 and a second SEL 84.

In the present embodiment, upon detecting that the downlink signal is not in the signal interruption state, the downlink signal interruption detection unit 45 gives the flag information, which indicates that the downlink signal is not in the signal interruption state, for example, the clock selection signal (CSS), which includes “0”, to the first SEL 83, the frequency deviation measurement unit 71 and the second SEL 84. Upon detecting that the downlink signal is in the signal interruption state, the downlink signal interruption detection unit 45 gives the flag information, which indicates that the downlink signal is in the signal interruption state, for example, the clock selection signal (CSS), which includes “1”, to the first SEL 83, the frequency deviation measurement unit 71 and the second SEL 84.

The clock extraction unit 46 gives the extracted OLT synchronization clock signal to the first SEL 83 and the frequency deviation measurement unit 71. The oscillator 47 gives the generated free-running clock signal to the first SEL 83 and the frequency deviation measurement unit 71. Moreover, the oscillator 47 gives the generated free-running clock signal as the reference clock signal (RCK) to the second time information management unit 82.

The time correction value generation unit 72 gives the generated time correction value (CV) to the second time information management unit 82. Based on the clock selection signal (CSS) including the flag information to be given from the downlink signal interruption detection unit 45, the first SEL 83 selects the OLT synchronization clock signal to be given from the clock extraction unit 46 or the free-running clock signal to be given from the oscillator 47.

In the case where it is detected that the downlink signal is not in the signal interruption state by the downlink signal interruption detection unit 45, then to the first SEL 83, “0” is given as the flag information from the downlink signal interruption detection unit 45. Upon being given “0” as the flag information from the downlink signal interruption detection unit 45, the first SEL 83 gives the OLT synchronization clock signal, which is to be given from the clock extraction unit 46, as the reference clock signal (RCK) to the ONU local timer unit 49 and the first time information management unit 81.

In the case where it is detected that the downlink signal is in the signal interruption state by the downlink signal interruption detection unit 45, then to the first SEL 83, “1” is given as the flag information from the downlink signal interruption detection unit 45. Upon being given “1” as the flag information from the downlink signal interruption detection unit 45, the first SEL 83 gives the free-running clock signal, which is to be given from the oscillator 47, as the reference clock signal (RCK) to the ONU local timer unit 49 and the first time information management unit 81.

The time information regeneration unit 50 gives the regenerated time information (RTI) to the first time information management unit 81. The first time information management unit 81 has a counter, which indicates the current time by counting up by the OLT synchronization clock signal to be given from the clock extraction unit 46 through the first SEL 83, or the free-running clock signal to be given from the oscillator 47.

The first time information management unit 81 corresponds to a synchronization time generation unit, a synchronization time management unit and a free-running time generation unit. A count value of the counter of the first time information management unit 81 corresponds to synchronization time information representing the current time or the free-running time information. The fact that the counter of the first time information management unit 81 counts up by the OLT synchronization clock signal corresponds to the fact that the synchronization time information is generated based on the OLT synchronization clock signal.

The first time information management unit 81 sets the counter for the regenerated time information (RTI) to be given from the time information regeneration unit 50. At predetermined timing, for example, when digits of a second after the decimal point become “0”, the first time information management unit 81 outputs, as the time information, the synchronization time information, which is the count value, or the free-running time information, and gives the outputted time information to the second SEL 84.

The second time information management unit 82 has a counter, which indicates the current time by counting up by the free-running clock signal to be given from the oscillator 47. The second time information management unit 82 corresponds to a free-running time information generation unit and a free-running time management unit. A count value of the counter of the second time information management unit 82 corresponds to free-running time information representing the current time. The fact that the counter of the second time information management unit 82 counts up by the free-running clock signal corresponds to the fact that the free-running time information is generated based on the free-running clock signal.

The second time information management unit 82 sets the counter for the regenerated time information (RTI) to be given from the time information regeneration unit 50. Moreover, based on the time correction value (CV) to be given from the time correction value generation unit 72 per unit time, for example, every 1 ms, the second time information management unit 82 corrects the count value. At predetermined timing, for example, when digits of a second after the decimal point become “0”, the second time information management unit 82 outputs, as the time information, the free-running time information, which is the corrected count value, and gives the outputted time information to the second SEL 84.

Based on the clock selection signal (CSS) including the flag information to be given from the downlink signal interruption detection unit 45, the second SEL 84 selects the time information, which is to be given from the first time information management unit 81, or the time information, which is to be given from the second time information management unit 82.

In the case where it is not detected that the downlink signal is in the signal interruption state by the downlink signal interruption detection unit 45, that is, in the case where it is detected that the downlink signal is not in the signal interruption state by the downlink signal interruption detection unit 45, then to the second SEL 84, “0” is given as the flag information from the downlink signal interruption detection unit 45. Upon being given “0” as the flag information from the downlink signal interruption detection unit 45, the second SEL 84 gives the time information, which is to be given from the first time information management unit 81, to the ONU interface unit 43.

In the case where it is detected that the downlink signal is in the signal interruption state by the downlink signal interruption detection unit 45, then to the second SEL 84, “1” is given as the flag information from the downlink signal interruption detection unit 45. Upon being given “1” as the flag information from the downlink signal interruption detection unit 45, the second SEL 84 gives the time information, which is to be given from the second time information management unit 82, to the ONU interface unit 43.

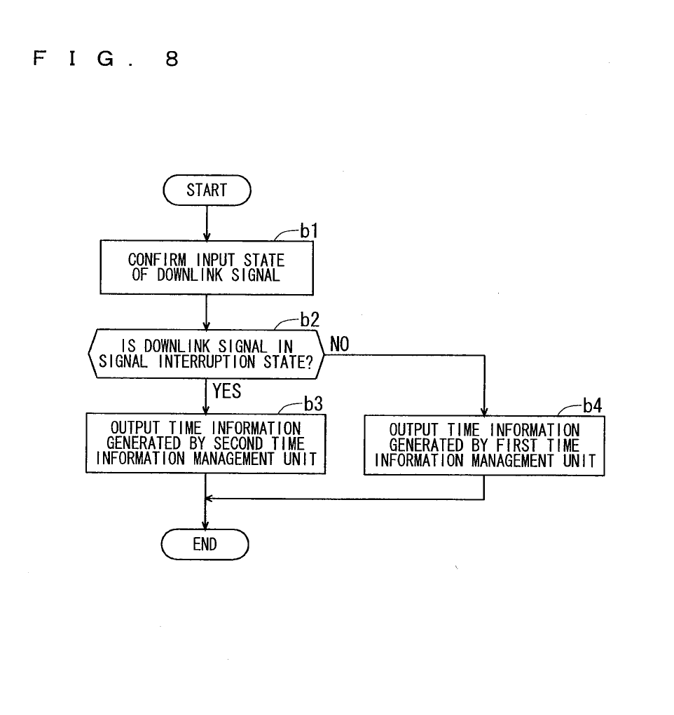

FIG. 8 is a flowchart showing a processing procedure regarding time information output processing in the ONU 2 of the second embodiment of the present invention. The respective pieces of processing, which are shown in FIG. 8, are executed by the downlink signal interruption detection unit 45 and second SEL 84 of the ONU 2. When electric power is supplied to the ONU 2 from an unillustrated power supply, the processing shown in the flowchart of FIG. 8 is started, and shifts to Step b1.

In Step b1, the downlink signal interruption detection unit 45 confirms an input state of the downlink signal. Specifically, the downlink signal interruption detection unit 45 confirms whether or not the downlink signal is inputted, or whether or not the signal level of the downlink signal is equal to or less than a predetermined threshold value. After the downlink signal interruption detection unit 45 confirms the input state of the downlink signal, the processing shifts to Step b2.

In Step b2, the downlink signal interruption detection unit 45 determines whether or not the downlink signal is in the signal interruption state based on the input state of the downlink signal, which is confirmed in Step b1. In the case where it is determined in Step b2 that the downlink signal is in the signal interruption state, the processing shifts to Step b3, and in the case where it is determined therein that the downlink signal is not in the signal interruption state, the processing shifts to Step b4.

In Step b3, the second SEL 84 gives the time information, which is generated by the second time information management unit 82, to the ONU interface unit 43. After the processing of Step b3 is ended, all of the processing procedure is ended.

In Step b4, the second SEL 84 gives the time information, which is generated by the first time information management unit 81, to the ONU interface unit 43. After the processing of Step b4 is ended, all of the processing procedure is ended.

In the above-mentioned first embodiment, the correction of the counter of the time information management unit 73, which is the time counter, is always performed, and accordingly, a time jump occurs though only slightly. This time jump turns to a non-problematic level in terms of actual use by shortening the unit time for the correction; however, preferably, is suppressed as much as possible.

Accordingly, in the present embodiment, a configuration is adopted, in which, in the case where the downlink signal to be inputted is present, that is, in the case where the downlink signal is not in the signal interruption state, the value of the counter of the first time information management unit 81, which is the time counter to be driven by the OLT synchronization clock signal, is used as the time information in a similar way to the underlying technology. In this way, high-accuracy time information can be generated.

Moreover, in the case where the downlink signal to be inputted is not present, that is, in the case where the downlink signal is in the signal interruption state, the same operations as in the first embodiment are performed. In this way, even at the time of the state where the time synchronization function is being used though the user traffic does not flow, the ONU 2 can be shifted to the cyclic sleep mode of turning the power supply of the ONU photoelectric conversion unit 41 to the OFF state. Hence, electric power saving of the ONU 2 can be achieved.

In the present embodiment described above, the second SEL 84 is configured so as to select whether to output the time information generated by the first time information management unit 81 or to output the time information generated by the second time information management unit 82 based on whether or not the downlink signal is in the signal interruption state; however, may have other configuration without being limited to such a configuration. For example, the second SEL 84 may be configured so as to select whether to output the time information generated by the first time information management unit 81 or to output the time information generated by the second time information management unit 82 based on control information to be given from the ONU PON control unit 44. A configuration in this case is described below.

A sleep allowing frame (hereinafter, referred to as “SAF” in some case) to the effect of allowing a sleep state of turning the power supply of the ONU photoelectric conversion unit 41 to the OFF state is contained in advance in the downlink signal to be transmitted from the OLT 11 to the ONU 2.

The ONU frame extraction unit 42 identifies and extracts the sleep allowing frame (SAF) together with the above-mentioned time synchronization frame (TSF), downlink PON control frame (DCF) and downlink user frame (DUF) from the downlink signal (DS) to be given from the ONU photoelectric conversion unit 41. The ONU frame extraction unit 42 gives the extracted sleep allowing frame (SAF) to the ONU PON control unit 44.

The ONU PON control unit 44 determines whether or not to shift to the sleep state based on the sleep allowing frame (SAF) to be given from the ONU frame extraction unit 42. The ONU PON control unit 44 gives the second SEL 84 sleep control information (hereinafter, referred to as “SCI” in some case) indicating whether or not to shift to the sleep state. The sleep control information (SCI) is information to the effect of shifting to the sleep state or information to the effect of not shifting to the sleep state.

The second SEL 84 selects whether to output the time information generated by the first time information management unit 81 or to output the time information generated by the second time information management unit 82 based on the sleep control information (SCI) to be given from the ONU PON control unit 44. Specifically, in the case where the sleep control information (SCI) to be given from the ONU PON control unit 44 is the information to the effect of not shifting to the sleep state, the second SEL 84 outputs the time information generated by the first time information management unit 81. In the case where the sleep control information (SCI) to be given from the ONU PON control unit 44 is the information to the effect of shifting to the sleep state, the second SEL 84 outputs the time information generated by the second time information management unit 82. Even in the case where the configuration is adopted as described above, similar effects to those in the present embodiment can be obtained.

### Third Embodiment

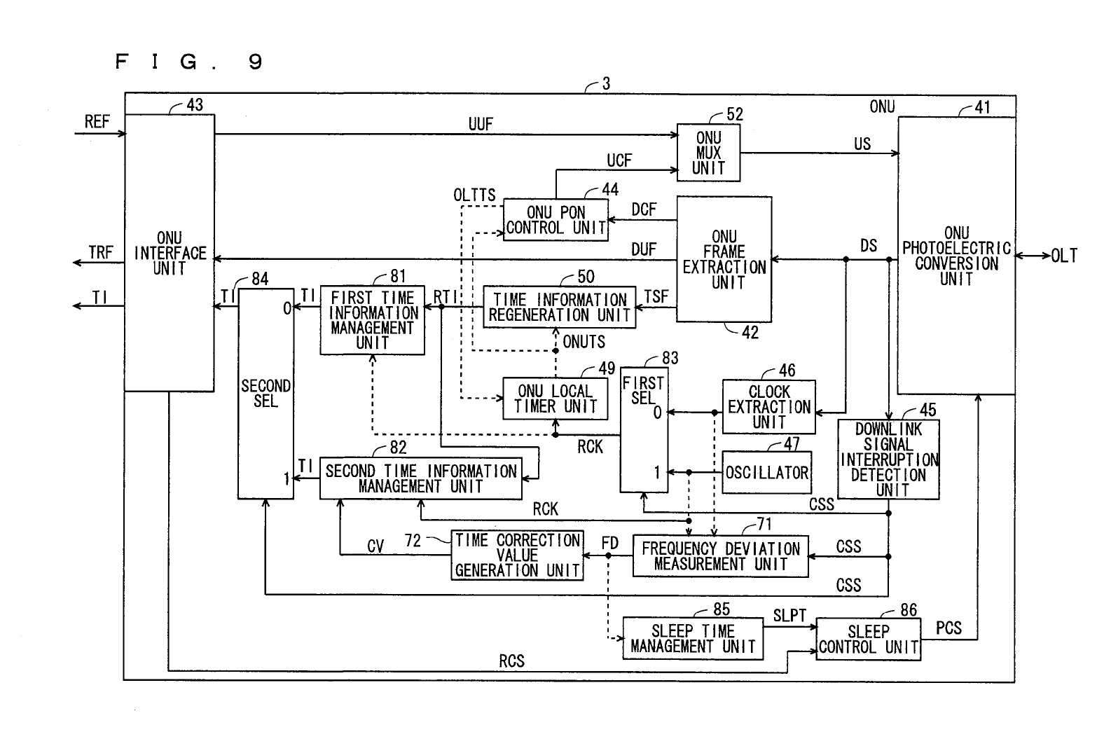

FIG. 9 is a block diagram showing a configuration of an ONU 3 in a third embodiment of the present invention. A configuration of the ONU 3 of the present embodiment, which is shown in FIG. 9, resembles the configuration of the ONU 2 of the second embodiment, which is shown in FIG. 7 mentioned above, and accordingly, a description is made only of different portions, and corresponding portions are added with the same reference numerals, and a common description is omitted.

In addition to the configuration of the ONU 2 in the above-mentioned second embodiment, the ONU 3 of the present embodiment includes a sleep time management unit 85 and a sleep control unit 86. That is to say, the ONU 3 is configured by including an ONU photoelectric conversion unit 41, an ONU frame extraction unit 42, an ONU interface unit 43, an ONU PON control unit 44, a downlink signal interruption detection unit 45, a clock extraction unit 46, an oscillator 47, an ONU local timer unit 49, a time information regeneration unit 50, an ONU MUX unit 52, a frequency deviation measurement unit 71, a time correction value generation unit 72, a first time information management unit 81, a second time information management unit 82, a first SEL 83, a second SEL 84, the sleep time management unit 85 and the sleep control unit 86.

In the present embodiment, the frequency deviation measurement unit 71 gives the measurement result of the measured frequency deviation (FD) to the time correction value generation unit 72 and the sleep time management unit 85.

Based on the measurement result of the frequency deviation (FD), which is to be given from the frequency deviation measurement unit 71, the sleep time management unit 85 measures a time change of the measurement result, and determines a holdover-capable time, that is, a time capable of maintaining the sleep state as a sleep permission time (hereinafter, referred to as “SLPT” in some case). The sleep time management unit 85 gives the determined sleep permission time (SLPT) to the sleep control unit 86.

The sleep control unit 86 controls the ONU photoelectric conversion unit 41 to switch the power supply of the ONU photoelectric conversion unit 41 from the ON state to the OFF state or from the OFF state to the ON state in such a manner as follows. In response to whether or not the traffic is present, and so on, the sleep control unit 86 generates a power supply control signal (hereinafter, referred to as “PCS” in some case) including instruction information for switching the power supply of the ONU photoelectric conversion unit 41 from the ON state to the OFF state or from the OFF state to the ON state. The sleep control unit 86 gives the generated power supply control signal (PCS) to the ONU photoelectric conversion unit 41.

Based on the power supply control signal (PCS) to be given from the sleep control unit 86, the ONU photoelectric conversion unit 41 switches the power supply from the ON state to the OFF state or from the OFF state to the ON state.

When the ONU 3 is not in the sleep state, the ONU photoelectric conversion unit 41 switches the power supply from the ON state to the OFF state, whereby the ONU 3 turns to the sleep state. When the ONU 3 is in the sleep state, the ONU photoelectric conversion unit 41 switches the power supply from the OFF state to the ON state, whereby the sleep state of the ONU 3 is released.

When the ONU 3 is in the sleep state, the sleep control unit 86 determines whether or not to maintain the sleep state of the ONU 3 based on the sleep permission time (SLPT) to be given from the sleep time management unit 85. Specifically, the sleep control unit 86 determines whether or not a time (hereinafter, referred to as “sleep continuation time” in some case) while the sleep state is being continued is equal to or more than the sleep permission time (SLPT) that is the time capable of maintaining the sleep state.

In the case where the sleep control unit 86 has determined that the sleep continuation time is equal to or more than the sleep permission time (SLPT) or more, the sleep control unit 86 switches the power supply of the ONU photoelectric conversion unit 41 from the OFF state to the ON state, and releases the sleep state. Specifically, the sleep control unit 86 generates a power supply control signal (PCS) including instruction information for switching the power supply of the ONU photoelectric conversion unit 41 from the OFF state to the ON state, and gives the generated power supply control signal (PCS) to the ONU photoelectric conversion unit 41. In this way, the power supply of the ONU photoelectric conversion unit 41 is switched from the OFF state to the ON state, and the sleep state is released.

The sleep control unit 86 is configured so as to be capable of determining whether or not the traffic is present. In the present embodiment, the sleep control unit 86 determines whether or not the traffic is present based on frame reception state information (hereinafter, referred to as “RCS” in some case) to be notified from the ONU interface unit 43. The frame reception state information (RCS) indicates a received state of the frame.

The ONU interface unit 43 notifies UUF presence information, which indicates whether or not the uplink user frame (UUF) is present, as the frame reception state information (RCS) to the sleep control unit 86. If the UUF does not flow for a fixed time, then the ONU interface unit 43 notifies UUF presence information, which indicates “no traffic is present”, to the sleep control unit 86. The ONU interface unit 43 receives the traffic. Specifically, upon receiving the UUF, the ONU interface unit 43 notifies UUF presence information, which indicates “traffic is present” to the sleep control unit 86.

When the ONU 3 is not in the sleep state, the sleep control unit 86 determines whether or not to shift the ONU 3 to the sleep state based on whether or not the traffic is present. Specifically, upon determining that the traffic is not present, the sleep control unit 86 controls the power supply of the ONU photoelectric conversion unit 41 from the ON state to the OFF state, and shifts the ONU 3 to the sleep state. Upon determining that the traffic is present, the sleep control unit 86 controls the ONU photoelectric conversion unit 41 to maintain the power supply of the ONU photoelectric conversion unit 41 in the ON state, and maintains the sleep state of the ONU 3.

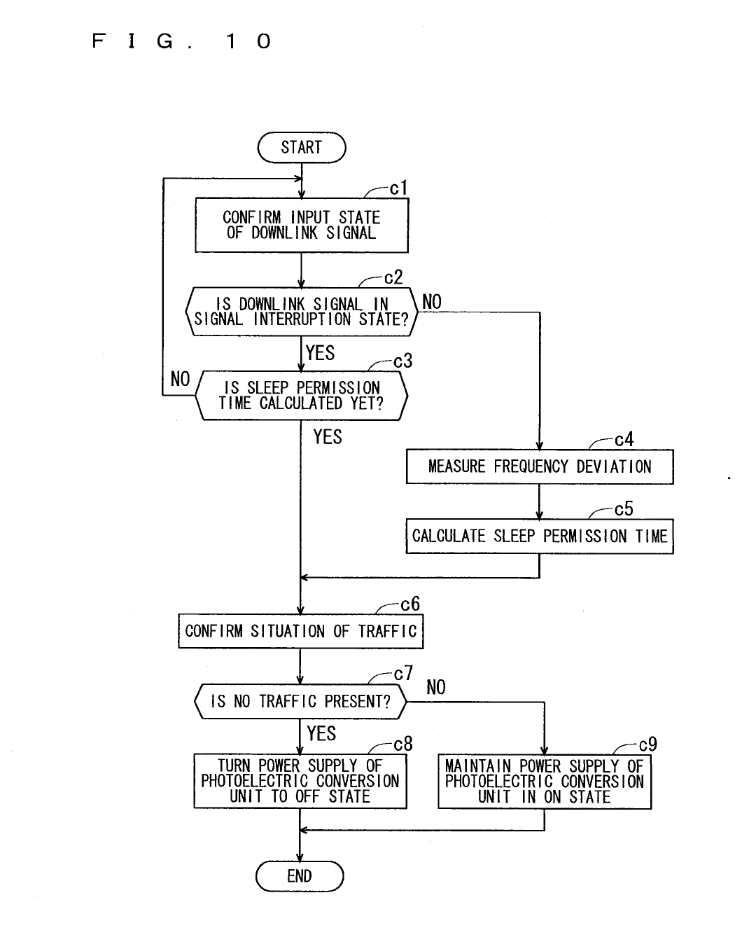

FIG. 10 is a flowchart showing a processing procedure regarding processing in the case where the ONU 3 in the third embodiment of the present invention is not in the sleep state. The respective pieces of processing, which are shown in FIG. 10, are executed by the downlink signal interruption detection unit 45, frequency deviation measurement unit 71, sleep time management unit 85 and sleep control unit 86 of the ONU 3.

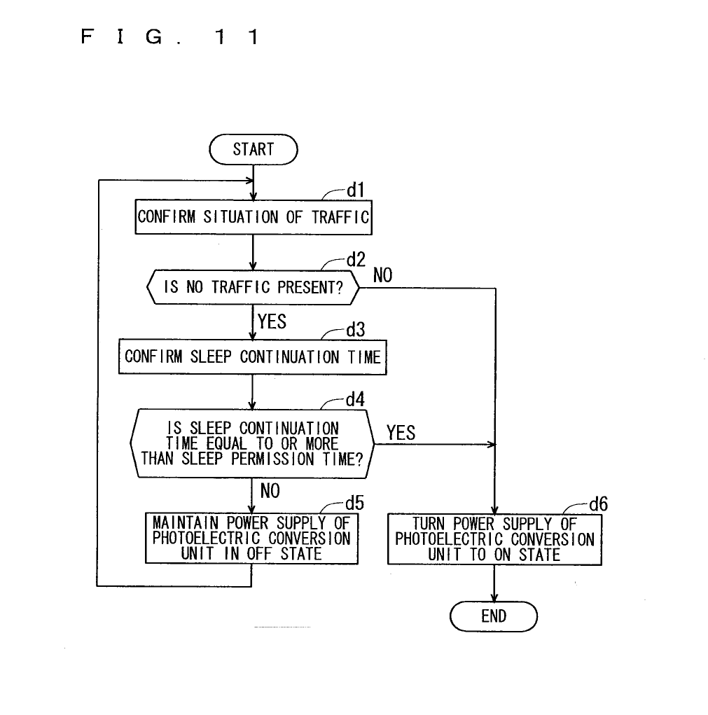

When the power supply of the ONU photoelectric conversion unit 41 turns to the ON state, the processing shown in the flowchart of FIG. 10 is started, and the processing shifts to Step c1. The power supply of the ONU photoelectric conversion unit 41 turns to the ON state, for example, when the supply of the electric power is started from the unillustrated power supply to the ONU 3, or the power supply of the ONU photoelectric conversion unit 41 is switched from the OFF state to the ON state in Step d6 of FIG. 11 to be described later.

In Step c1, the downlink signal interruption detection unit 45 confirms an input state of the downlink signal. Specifically, the downlink signal interruption detection unit 45 confirms whether or not the downlink signal is inputted, or whether or not the signal level of the downlink signal is equal to or less than a predetermined threshold value. After the downlink signal interruption detection unit 45 confirms the input state of the downlink signal, the processing shifts to Step c2.

In Step c2, the downlink signal interruption detection unit 45 determines whether or not the downlink signal is in the signal interruption state based on the input state of the downlink signal, which is confirmed in Step c1. In the case where it is determined in Step c2 that the downlink signal is in the signal interruption state, the processing shifts to Step c3, and in the case where it is determined therein that the downlink signal is not in the signal interruption state, the processing shifts to Step c4.

In Step c3, the sleep time management unit 85 determines whether or not the sleep permission time (SLPT) is already calculated. In the case where it is determined in Step c3 that sleep permission time (SLPT) is already calculated, the processing shifts to Step c6, and in the case where it is determined therein that the sleep permission time (SLPT) is not calculated yet, the processing returns to Step c1, and the above-mentioned processing is repeated.

In Step c4, the frequency deviation measurement unit 71 measures the frequency deviation (FD) in a similar way to the above-mentioned second embodiment. After the frequency deviation (FD) is measured, the processing shifts to Step c5.

In Step c5, the sleep time management unit 85 calculates the sleep permission time (SLPT) as mentioned above. After the sleep permission time (SLPT) is calculated, the processing shifts to Step c6.

In Step c6, the sleep control unit 86 confirms a situation of the traffic. Specifically, the sleep control unit 86 confirms whether or not the traffic is present. After the sleep control unit 86 confirms the situation of the traffic, the processing shifts to Step c7.

In Step c7, the sleep control unit 86 determines whether or not the traffic is not present based on a confirmation result of Step c6. In the case where the sleep control unit 86 has determined that the traffic is not present in Step c7, the processing shifts to Step c8, and in the case where the sleep control unit 86 has determined that the traffic is present, the processing shifts to Step c9.

In Step c8, the sleep control unit 86 shifts the power supply of the ONU photoelectric conversion unit 41 from the ON state to the OFF state, and turns the ONU 3 to the sleep state. After the end of the processing of Step c8, all of the processing procedure is ended.

In Step c9, the sleep control unit 86 maintains the power supply of the ONU photoelectric conversion unit 41 in the ON state. After the end of the processing of Step c9, all of the processing procedure is ended.

FIG. 11 is a flowchart showing a processing procedure regarding processing in the case where the ONU 3 in the third embodiment of the present invention is in the sleep state. The respective pieces of processing, which are shown in FIG. 11, are executed by the sleep control unit 86. When the power supply of the ONU photoelectric conversion unit 41 is switched from the ON state to the OFF state in Step c8 shown in FIG. 10 mentioned above, and the ONU 3 turns to the sleep state, then the processing shown in the flowchart of FIG. 11 is started, and the processing shifts to Step d1.

In Step d1, the sleep control unit 86 confirms the situation of the traffic. Specifically, the sleep control unit 86 confirms whether or not the traffic is present. After the sleep control unit 86 confirms the situation of the traffic, the processing shifts to Step d2.

In Step d2, the sleep control unit 86 determines whether or not the traffic is not present based on a confirmation result of Step d1. In the case where the sleep control unit 86 has determined that the traffic is not present in Step d2, the processing shifts to Step d3, and in the case where the sleep control unit 86 has determined that the traffic is present, the processing shifts to Step d6.

In Step d3, the sleep control unit 86 confirms the sleep continuation time. After the sleep control unit 86 confirms the sleep continuation time, the processing shifts to Step d4.

In Step d4, the sleep control unit 86 determines whether or not the sleep continuation time is equal to or more than the sleep permission time (SLPT). In the case where the sleep control unit 86 has determined in Step d4 that the sleep continuation time is not over the sleep permission time (SLPT), that is, that the sleep continuation time is less than the sleep permission time (SLPT), the processing shifts to d5, and in the case where the sleep control unit 86 has determined that the sleep continuation time is equal to or more than the sleep permission time (SLPT), the processing shifts to Step d6.

In Step d5, the sleep control unit 86 maintains the power supply of the ONU photoelectric conversion unit 41 in the OFF state. In this way, the ONU 3 is maintained in the sleep state. After the end of the processing of Step d5, the processing returns to Step d1, and the above-mentioned processing is repeated.

In Step d6, the sleep control unit 86 switches the power supply of the ONU photoelectric conversion unit 41 from the OFF state to the ON state. In this way, the sleep state of the ONU 3 is released. After the end of the processing of Step d6, all of the processing procedure is ended.

In accordance with the present embodiment described above, the following effects are obtained. The deviation of the clock signal varies with time, and accordingly, even if the above-mentioned first and second embodiments are used, if the signal interruption state of the downlink signal continues for a long time, the accuracy of the time is deteriorated. As opposed to this, in the present embodiment, when the sleep continuation time becomes equal to or more than the sleep permission time (SLPT), the power supply of the ONU photoelectric conversion unit 41 is switched from the OFF state to the ON state, and the sleep state of the ONU 3 is released. Hence, before the accuracy of the time exceeds a permissible amount of the PON system, the ONU 3 can be released from the sleep state.

Moreover, in the present embodiment, in the case where it is determined that the traffic is not present, the power supply of the ONU photoelectric conversion unit 41 is switched from the ON state to the OFF state, and the ONU 3 is shifted to the sleep state. Hence, the ONU 3 is turned to the sleep state without inhibiting communication between the ONU 3 and the OLT 11, and the electric power saving of the ONU 3 can be achieved.

Although the description has been made of the present invention in detail, the above description is an illustration in all aspects, and the present invention is not limited to this. It is interpreted that unillustrated countless modification examples are imaginable without departing from the scope of the present invention.

### EXPLANATION OF REFERENCE NUMERALS

1 ONU, 41 ONU PHOTOELECTRIC CONVERSION UNIT, 42 ONU FRAME EXTRACTION UNIT, 43 ONU INTERFACE UNIT, 44 ONU PON CONTROL UNIT, 45 DOWNLINK SIGNAL INTERRUPTION DETECTION UNIT, 46 CLOCK EXTRACTION UNIT, 47 OSCILLATOR, 48 SEL, 49 ONU LOCAL TIMER UNIT, 50 TIME INFORMATION REGENERATION UNIT, 52 ONU MUX UNIT, 71 FREQUENCY DEVIATION MEASUREMENT UNIT, 72 TIME CORRECTION VALUE GENERATION UNIT, 73 TIME INFORMATION MANAGEMENT UNIT, 81 FIRST TIME INFORMATION MANAGEMENT UNIT, 82 SECOND TIME INFORMATION MANAGEMENT UNIT, 83 FIRST SEL, 84 SECOND SEL, 85 SLEEP TIME MANAGEMENT UNIT, 86 SLEEP CONTROL UNIT.

1. A subscriber-side device provided in an optical transmission system in which a station-side device and a plurality of said subscriber-side devices perform communication through optical transmission lines, said subscriber-side device comprising:
a receiving unit that receives a downlink signal to be transmitted from said station-side device;
a synchronization clock generation unit that generates a synchronization clock signal based on said downlink signal received by said receiving unit, said synchronization clock signal being synchronized with said station-side device;
a free-running clock generation unit that generates a free-running clock signal serving as a reference at a time when said subscriber-side device operates independently of said station-side device;
a free-running time generation unit that generates free-running time information based on said free-running clock signal, said free-running time information indicating a current time;
a frequency deviation measurement unit that measures a frequency deviation between said synchronization clock signal and said free-running clock signal;
a correction information generation unit that, based on said frequency deviation, generates correction information for correcting said free-running time information;
a time information management unit that corrects and outputs said free-running time information based on said correction information; and
a downlink signal interruption detection unit that detects that said receiving unit is in a signal interruption state of being incapable of recognizing or receiving said downlink signal,
wherein, in the case where it is detected that said receiving unit is in said signal interruption state by said downlink signal interruption detection unit, said time information management unit corrects and outputs said free-running time information based on said correction information generated, before it is detected that said receiving unit is in said signal interruption state, by said correction information generation unit.

2. The subscriber-side device according to claim 1, comprising:
a synchronization time generation unit that generates synchronization time information based on said synchronization clock signal, said synchronization time information indicating the current time,
wherein said time information management unit includes:
a free-running time management unit that, in the case where it is detected that said receiving unit is in said signal interruption state by said downlink signal interruption detection unit, corrects and outputs said free-running time information based on said correction information; and
a synchronization time management unit that, in the case where it is not detected that said receiving unit is in said signal interruption state by said downlink signal interruption detection unit, outputs said synchronization time information to be generated by said synchronization time generation unit.

3. The subscriber-side device according to claim 1,
wherein said receiving unit has a power supply capable of switching between an ON state and an OFF state,
the subscriber-side device includes:
a sleep control unit that controls said receiving unit to switch the power supply of said receiving unit from the ON state to the OFF state or from the OFF state to the ON state; and
a sleep time management unit that determines a sleep permission time based on a time change of a measurement result of said frequency deviation, said sleep permission time indicating a time capable of maintaining a sleep state that is a state where the power supply of said receiving unit is the OFF state, and
upon determining, when the subscriber-side device is in said sleep state, that a sleep continuation time representing a time while said sleep state is being continued is equal to or more than said sleep permission time, said sleep control unit controls said receiving unit to switch the power supply of said receiving unit from the OFF state to the ON state, and releases said sleep state.

4. The subscriber-side device according to claim 3,
wherein said sleep control unit is configured to be capable of determining whether or not traffic is present, and
(a) upon determining that the traffic is not present when the subscriber-side device is not in said sleep state, said sleep control unit controls said receiving unit to switch the power supply of said receiving unit from the ON state to the OFF state, and shifts the subscriber-side device to said sleep state, and (b) upon determining that the traffic is present when the subscriber-side device is not in said sleep state, said sleep control unit controls said receiving unit to maintain the power supply of said receiving unit in the ON state, and to maintain said sleep state.

5. An optical transmission system in which a station-side device and a plurality of subscriber-side devices perform communication through optical transmission lines,
wherein said subscriber-side device is the subscriber-side device according to claim 1.
